(19) United States
(12) Patent Application Publication
(10) Pub. No.: US 2018/0276618 A1
(43) Pub. Date: Sep. 27, 2018

(54) MOBILE APP CONNECTING EMPLOYEE AND EMPLOYER THROUGH GPS

(71) Applicant: Amarlal Gopilal Nichani, Chennai (IN)

(72) Inventor: Amarlal Gopilal Nichani, Chennai (IN)

(21) Appl. No.: 15/547,486

(22) PCT Filed: Feb. 1, 2016
(86) PCT No.: PCT/IN2016/000033

§ 371 Date: Jul. 29, 2017

(30) Foreign Application Priority Data
Feb. 11, 2015 (IN) 670/CHE/2015

(51) Int. Cl. G06Q 10/10; H04W 4/02; H04L 29/08

(52) U.S. Cl. CPC G06Q 10/1053; H04W 4/023; H04W 4/14; H04L 67/26; G06Q 10/1095; H04L 67/306

(57) ABSTRACT

An App which enables the communications through GPS, between the devices of job provider and job seeker by means of an alert issued to both the devices based on mutual matches of the job seeker's profile and job provider's requirement, when the devices are within a predetermined radius of each other.

### FIELD OF INVENTION

This is the complete specification claiming priority from Application No. 670/CHE/2015 titled ‘A MOBILE HR APPLICATION TO CONNECT EMPLOYEE AND EMPLOYER THROUGH GPS’, filed on 11 Feb. 2015, relating to a communication tool which enables two sets of devices to identify and locate each other, the said devices being connected by means of a downloaded app, which generates an alert once the devices are within a preset distance from each other and the uploaded criteria match. It is a method which finds its use in situations wherein job seeker and job provider get connected to one another on their devices; once registered through an App, when the said devices come within a predetermined radius of each other, based on their requirements being matched, the requirements get matched based on their common criteria. This invention is also a tool to connect two persons to identify each other based on matching of criteria laid down by them for any other common interest based on mutual requirements and a casual work force connecting to a client for a day's work once the mutual conditions match and In all these and many more such situations, once there is a match based on the data input received from the devices, an alert is received on their respective devices, once the devices are within a preset distance from each other, displaying the availability of the other device and the device owners call each other based on the display on their screen to fix an actual meeting in person.

Indian Patent Number 238729 dated 22 Jan. 2004 relates to an invention directed to a system and method for providing real-time position information of one party to another party by utilizing a conventional telecommunication network system such as the convention telephone network, a mobile telecommunication network, a computer network, or the Internet. More specifically, the preferred embodiments of the invention allow a caller and a receiver of a telephone call to provide to and receive from each other position information related to the caller and/or receiver's physical location, including address information, GPS coordinates, nearby fixed location such as a parking structure, etc. Additionally, the preferred embodiments of the present invention allow a caller and receiver to retrieve routing instructions or maps for traveling to or from each other. In another embodiment of the present invention, a party may locate the position of another party via the entry of the other party's unique identifier such as a phone number of the other party's mobile phone. In yet another embodiment of the present invention, the position of a party may be concurrently delivered to another party's computer terminal whereby the other party can process the information in further details. This invention relates to locating the other party based on the mobile number of the first party whereas the present invention relates to locating the parties by means of matching criteria and location. The interaction over the phone takes place only when an alert is issued under the present invention.

### BACKGROUND OF THE INVENTION

The current system of recruiting is to fix a meeting between the prospective employers and employees and there is a time lag between the date of applying, attending the interview and joining the job. The present inventions seeks to do away with this and works on real time, wherein by using the mobile App of the present invention, the employees and employers are asked to submit their profiles and this application helps the prospective employee and employer to get connected when they are mutually compatible with regard to requirements from both ends, facilitating a meeting between the two parties, when the device owners come in close proximity to one another within the configured radius, by means of notifications on their respective mobiles. This invention helps in working on real time mode and does away with the time lag in communication between the job provider and job seeker which is a huge plus in todays' world of instant communication. Furthermore, if this App of the present invention is used by the personnel from the employer directly, it offers meritorious candidates a direct chance to interact with prospective employers, doing away with partiality by the HR department.

This invention works on two conditions i.e. matching of both criteria and when the devices are within a predetermined range of each other. The pre-requisite to make it happen is to download the app and register the individual requirements of both the job provider and the job seeker, along with the basic details and select the method of receiving the alerts. The communication devices so registered sense the other related device location through location listeners of the Mobile Operating System and are ready to connect once they are within a configured radius and with this the service of the App ends and the prospective owners of the devices thereafter establish their contact as per the details available in the notification screen. The job provider can view profiles of prospective candidates and similarly the job seeker also can view prospective employers on the mobile. This communication tool is very useful where the device owners pay visit to events like ‘Job Fairs’, Conferences, seminars, and even in homes, street corners, Airports, Railway station, amusement parks, malls and pretty much anywhere and everywhere, as whenever they come in close proximity to each other in these places they get connected to one another through their devices.

### BRIEF DESCRIPTION OF THE INVENTION

The present invention seeks to provide an App and service which enables the communication by means of an alert issued to both the devices based on mutual matches, when the devices are within a predetermined radius of each other. This is a mobile application in which the owners of the devices are asked to submit their profiles and this application helps the respective device owner to connect to the other device owner when they are mutually compatible with the pre-filled information of qualities, skill sets and mutual expectations, when both come in close proximity to one another within the configured radius by notifications on their respective devices by a means of an alert.

In this communication App, a profile matching service helps to identify and bring together two or more people i.e. employees and employers, casual labour and client, two interested parties with common interests, when they are within a predetermined distance of each other. Many web portals are already available for HR related services which only makes it possible for the employees to upload their profile and they get an opportunity to be called by the employers only if the employer's HR staff happen to view the employee's profile on the different websites in manual searches. So, there is a good chance of missing the right candidates by the employers and a suitable job by the employees. The same is true in case of other class of users when a third party like the HR executive get involved.

Whereas by using this Mobile App, whenever two device owners who have already filled in their profile through the Apps on their device come close to one another within the configured radius, they will get a notification by an alert on their respective devices and both the device owners can respond to the alert and take it to the next level like coming face to face and look for their areas of compatibility in the domain they are looking for like in HR cases if found mutually suitable, immediate job appointment could take place or they can take their candidature further by scheduling an interview in person or through phone. Thus this App is a great tool for any set of interested mutually exclusive people to communicate with each other without the involvement of a third party to help them connect.

The broad sequence of steps for using this facility common to both prospective employer and employee are
1. Mobile Number Unique verification.
2. Registration Process for Push Notification Service.
3. Code verification.
4. Profile and requirement filling.
5. Location Updates.
6. Notifying Job seeker and Job Provider by buzzer, rings/vibrations.

### BRIEF DESCRIPTION OF THE DRAWINGS

FIG. 1 the Basic components of the invention along with the third party service like Push notification service and unique and novel service of SMS API is depicted.

FIG. 2 illustrates the steps involved in device number unique verification.

FIG. 3 illustrates the registration process of the devices on Push Notification Service.

FIG. 4 illustrates the steps involved in code verification process of the devices.

FIG. 5 illustrates the process flow of profile and requirement filling of the different devices.

FIG. 6 illustrates the steps involved in capturing location updates.

FIG. 7 illustrates the steps involved in notifying the Device Owners of location and matched profiles.

The figures described above are a representative set, and are not exhaustive with respect to embodying the invention.

### DETAILED DESCRIPTION OF THE DRAWINGS WITH PREFERRED EMBODIMENTS

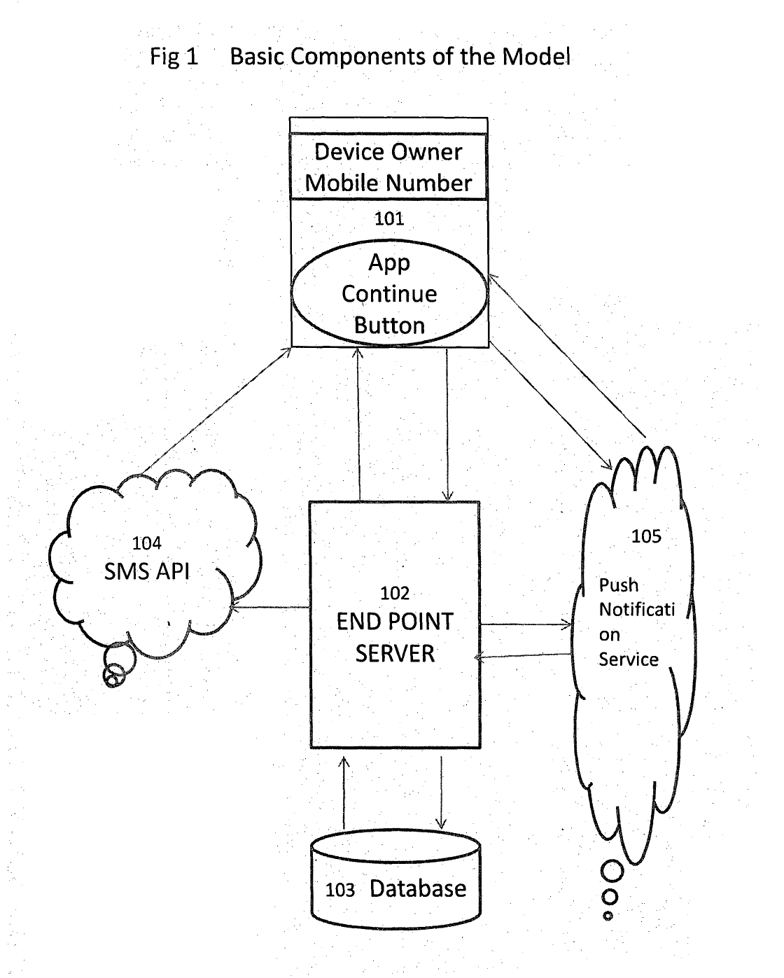

FIG. 1 illustrates the overall system diagram of the various entities present in the working of the invention and the broad channels of communication and interactions that exist among the components. The most basic and important aspect of this invention is the process of the registration which involves interested 101 device owners down load the App and engage in the authentication and verification using an 102 End Point Server (EPS) template with code which is generated for each device and through the 104 SMS API sent to the devices after initial steps of acceptance of terms are completed and verification token generated by the 103 Data base (DB) of the 102 End Point Server sent to them separately. The verification token along with the device owner details and acceptance of conditions are stored on the 103 database connected to the End Point Server. The next step involves the registration process of the devices on the 105 Push Notification Service. Further, the steps involved in the code verification as a step towards device authentication where in the 102 End Point Server verifies the device entered code which was sent by the 104 SMS API to devices earlier with stored token on 103 DB. If they match, the 102 EPS allows the device to proceed to the next step, else it instructs the device to resend correct code. Next are the steps involved in capturing the profile and requirement filling sent by the 101 device owners on a screen that is provided to enter the information. Apart from this, the step involves enabling the GPS, get notifications and sharing of information through social networking and e-mail. Now, as the next act, updating the location updates continuously sent by the 101 devices to the 102 End Point. Server which gets stored on the 103 Data Base connected to the same. Lastly, the requirements of the device owners are met by the intelligent system on 102 End Point Server where in the 101 devices are updated on the matching conditions on profiles and location using the 105 Push Notification Service. The EPS 102 is constantly communicating to the device 101. Further details of each of the components and their inter-communication pertaining to each series are explained below.

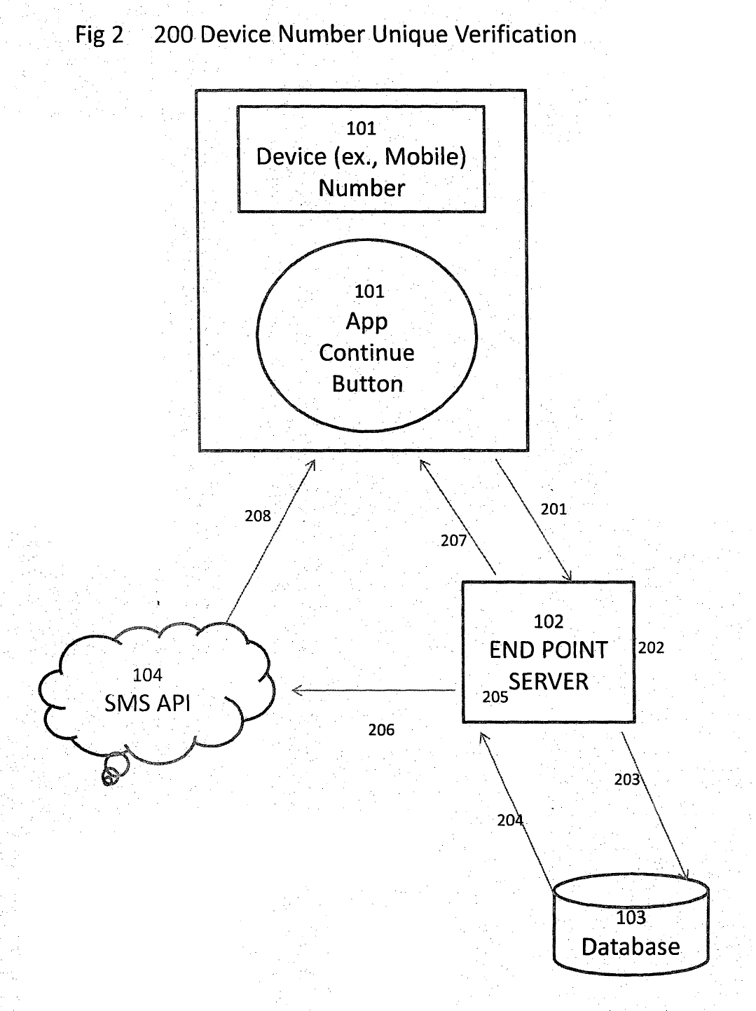

FIG. 2 illustrates the design of the Device Number Unique verification module suitable for verification of the communication 101 devices. The App is downloaded on to the respective 101 devices by the Device Owner/user who wants to utilize the service. The User is then asked to read the Privacy Policy and Terms and Conditions and then agree. Further the user needs to select the User category such as Job Seeker or Job provider, seller, buyer etc. He or she selects the version of the device application. Then the Device Owner enters his device number and commits by pressing the continue button. Using Path 201, the details entered above are sent to the 102 End Point Server (EPS). Step 202 The End Point Server 102 generates a verification code after due verification. Further using path 203, the data gets stored/inserted into the 103 Data Base (DB) on the server. The 103 DB generates a verification token and through step 204 sends to 102 EPS. Step 205, the 102 End Point Server (EPS) generates a SMS template with code. 206 SMS template with code is sent to 104 SMS API. 207 EPS (102) sends Verification token to App on the User 101 Device. 208 The EPS 102 generated template with code sends SMS to Application on the 101 Device with the specific device Number through 104 SMS API.

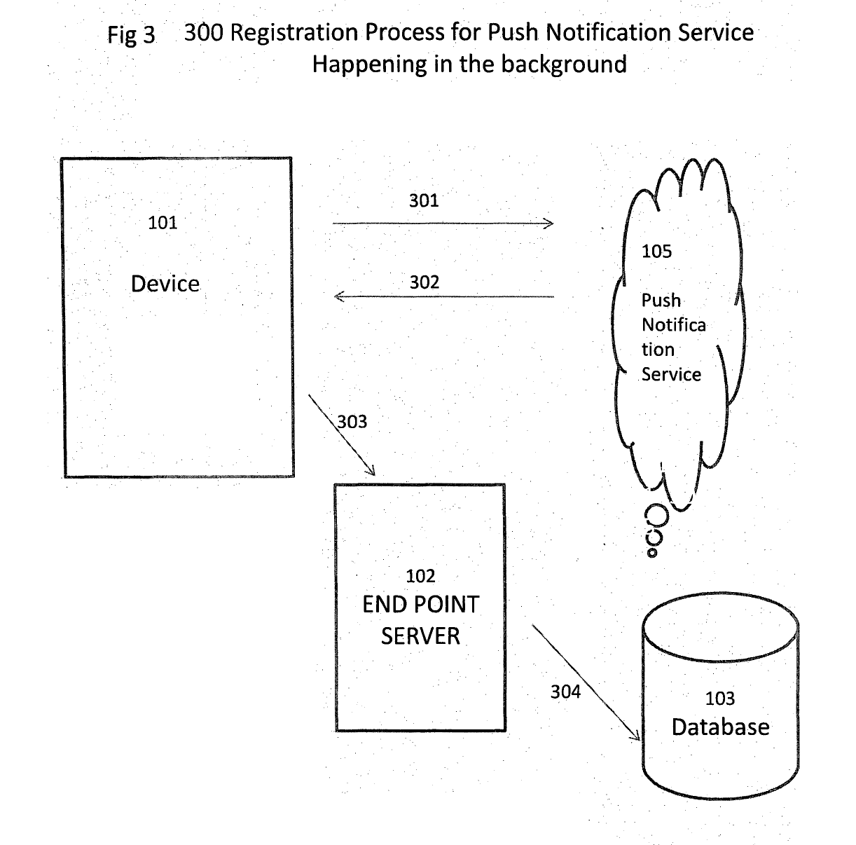

FIG. 3 illustrates the steps happening in the background during the Registration Process for 105 Push Notification Service of 101 Device. In order to communicate with the 101 devices on real time, the 102 End Point Server requires the Push Notification Registration and Push Notification Registration ID. Path 301, the 101 Device Owner App sends Push Notification sender ID and Application ID to 105 Push Notification Server (PNS) on cloud. Path 302 Upon Successful registration, Push Notification Server (PNS) issues a 256 Bit Registration ID to the 101 Device. As Path 303, this device, after receiving the 256 Bit Registration ID, sends the Registration ID to the 102 End Point Server (EPS). Further, Path 304, the 256 Bit Push Notification Registration ID gets stored on the data base against the 101 Device Owner's device number.

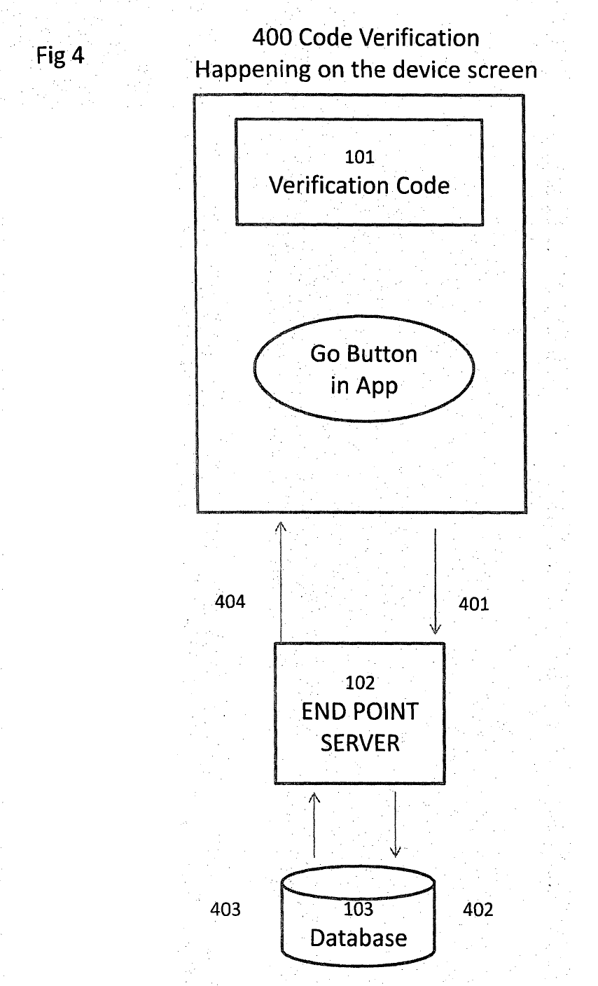

FIG. 4 illustrates the steps involved in the code verification process of the 101 Devices. Step 401, the App on the 101 Device Owner's devices sends the verification code by the 104 SMS API and the verification token to the 102 EPS. This is similar to path 303 happening in the background. 402 The Data Base 103 compares verification code with verification token. The 103 Data Base creates a result of the comparison of the verification code with verification token on the 103DB. Step 403, this information is sent to the 102 End Point Server which gets referred back to the Device App. Step 404, if the Device Owner's verification token and verification code match on the App, then it continues with the next process and if there is a mismatch then the Device Owner's device 101 Application prompts the user to verify again. This is similar to path 304 happening in the background. The Registration process described in FIG. 3 and the Code Verification process described in FIG. 4 happen simultaneously, wherein the process in FIG. 3 happens in the background and the process in FIG. 4 happens on the screen of the device 101.

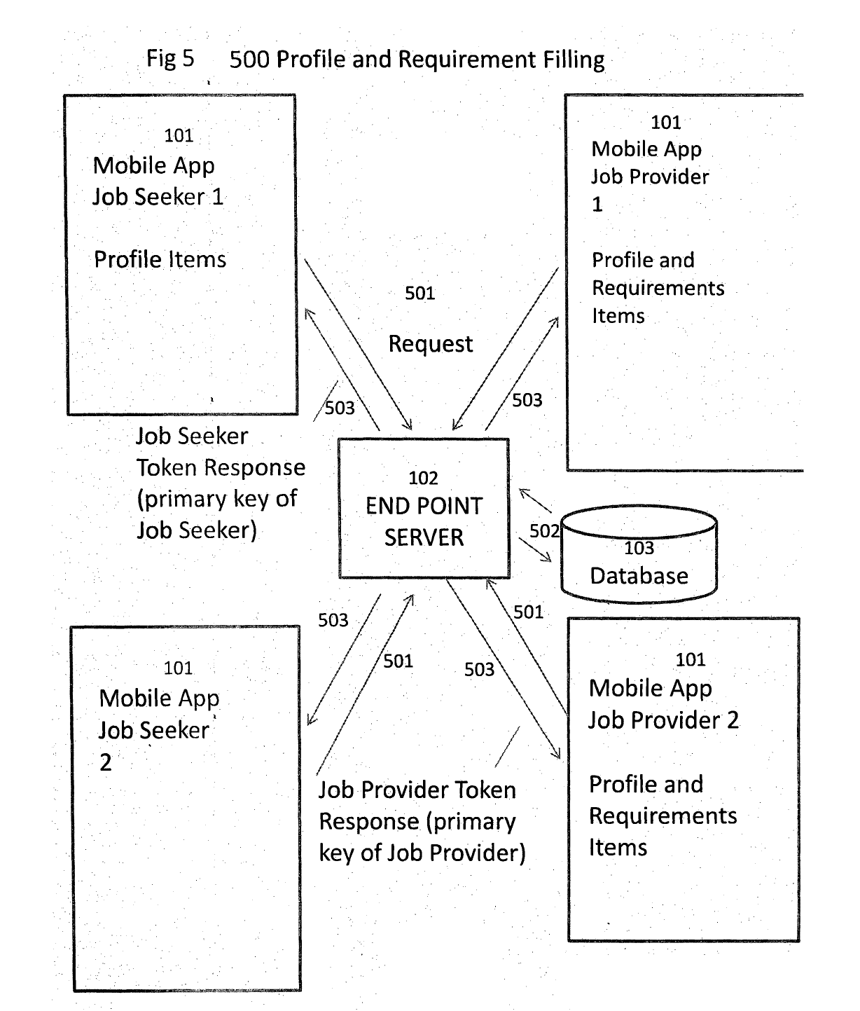

FIG. 5 illustrates the steps for filling the profile and requirement of the 101 device owners according to some embodiments. As the next process, the 101 Device owner selects whether he or she is a job seeker or job provider. The Job seeker's application opens an introductory screen with four options Viz., Profile, HR Alert, Notification, and Share in case of HR. As an example, if the owner chooses the Profile option, the Job Seeker's application requests the Job Seeker to fill up his profile Viz. Add Photo, First Name, Last Name, Qualification, Fresher/Employee/Freelancer, Designation, Area, City, Present Company, experience, Mobile, Skill sets, Email Address, attach resume and freeze the profile. The job seeker can change his profile when there is a change in his skill set which is not possible for a job provider after freezing the requirements. The job provider can only change the information pertaining to the company such as address, phone numbers, websites etc but not the requirements once frozen. 101 The Device Owner then goes to the Notification screen to check the ON/Off button. If this button is in OFF position, then there will be an alert on the device asking the 101 Device Owner to enable the Global Positioning System (GPS). Further, the Device Owner's Notification Screen also has three mode of Alerts (i) Ring, (ii) Vibrate, (iii) vibrate and ring. The 101 Device Owner makes a choice here to one of them which can be changed later, if required. The Device Owner's HR Alert Screen is there to get Alerts about the available jobs. An alert is issued to the device by means of an icon displayed on the menu bar of the device. A list of job providers is displayed and the information filled in the profile screen of the job provider will be displayed when clicked upon. The job seeker then can contact the job provider by any of the means listed therein and schedule an interview. Further, The Device Owner's share screen provides option to share the App by Bluetooth, copy to clipboard, drive, email, gmail, google+, hangouts, memo, messages, whatsapp, wifi direct, share it, skype, viber and/or any other such facility likely to be used in future for sharing and storing. Step 501, the job seeker Profile is sent to 102 End Point Server. Step 502, The 102 End Point Server obtains the 101 job seeker's Token Response from the 103 Data Base (DB). Step 503, the 102 End Point Server sends a job seekers Token Response (Primary Key) to that 101 job seeker. Now the 101 job seeker's device is all set to receive the alerts. Multiple job seekers can register at the same time.

In case of the 101 Job provider the initial activity remains similar. First, the 101 Job provider's application opens with an introductory screen. The 101 Job provider's application now provides five screens namely Profile, Requirement, Candidate Alert, Notification and Share. The Job Provider's application in the profile screen asks the Job Provider to fill up entity profile such as Adding Logo, Entity Name, Area, City, Registered/Alternative Phone Number, email, Website and freeze the company details and click on the save button. If the Job Provider wishes to update any of changes in the Entity details, he can do so and click on the Update Button. The next step is to proceed to the requirement screen, wherein three options are provided for the job provider to select with regard to the constitution of the entity whether the entity is hiring for itself in which event the job provider clicks on Direct. In the event the hiring is on behalf of another, then the job provider has to state whether it's a consultancy or a freelancer. The next step is to fill in the details of the employer such as Employer Name, Designation, Required Skill sets (which is to be selected from an existing set of skills from a preloaded database), Job Location, Experience, Salary and the job provider then clicks on the save button to freeze the requirement. The job provider cannot edit the requirements with regard to skill sets once it is frozen. The present invention seeks to levy a payment mode for use of the App. Both, or either the job seeker or the job provider may have to pay for use of the App, in which case, there is a payment gateway through which the payment is made.

The job provider can register for multiple entities or multiple vacancies for the same entity. All the requirement options are serviced simultaneously. Later, as in the case of the 101 job provider goes to the Notification screen to choose ON/OFF button. If it is in OFF position there will be an alert asking the 101 Job provider to enable GPS. The 101 Job provider's Notification Screen also has three modes of Alerts (i) Ring, (ii) Vibrate, (iii) vibrate and ring. The 101 Job provider has to make a choice here to one of them which can be changed later, if required. Lastly, the 101 Job provider's Candidate Alert Screen is provided to alert the available candidates when they come in the programmed proximity. The 101 Device Owner's share screen provides sharing by Bluetooth, copy to clipboard, drive, email, gmail, google+, hangouts, memo, messages, whatsapp, wifi direct, share it, skype, viber and/or any other such facility likely to be used in future for sharing and storing. 101 Job provider Profile is sent to 102 End Point Server. The 102 End Point Server sends a 101 Job provider Token Response (Primary Key) to the 101 Job provider.

Now the 101 Job provider's device is all set to receive the alerts. An alert is issued to the device by means of an icon displayed on the menu bar of the device. A list of job seekers are displayed and the information filled in the profile screen of the job seeker will be displayed when clicked upon. The job provider then can contact the job seeker by any of the means listed therein and schedule an interview. Multiple job provider's can register at the same time. The job provider can also share the App in the same manner as the job seeker. Multiple job seeker's and job provider's devices are ready to receive alerts once registered, following the procedures laid herein above.

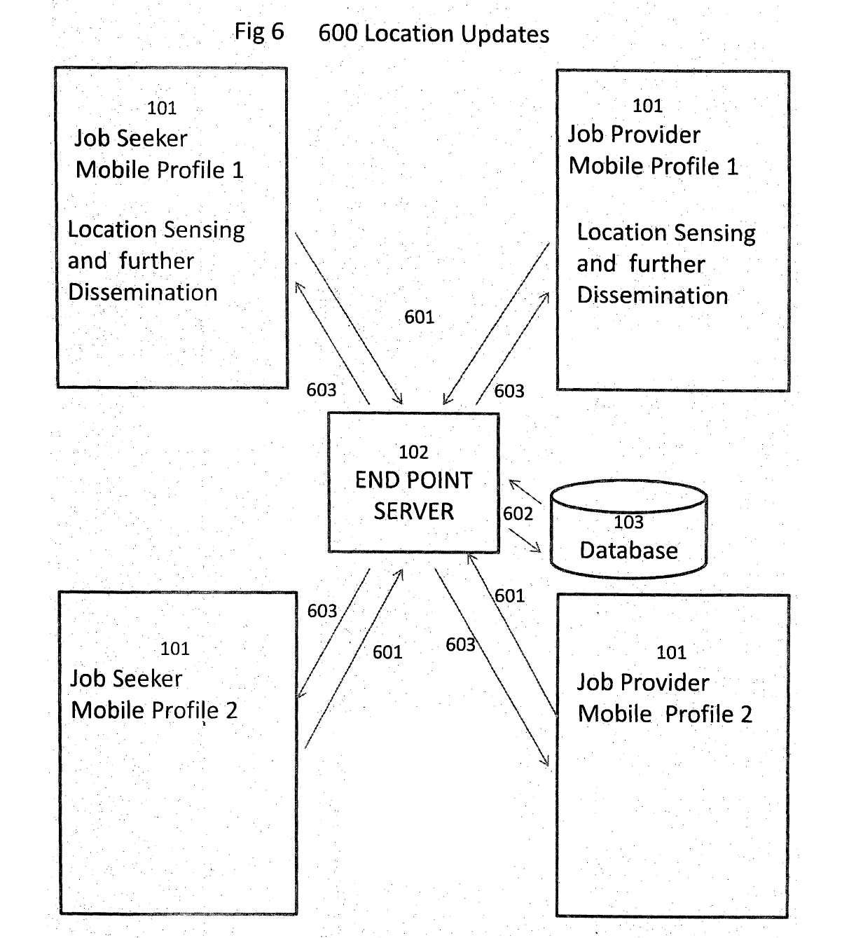

FIG. 6 illustrates the process of obtaining and updating the location information of 101 Device Owners from their respective Devices to the 102 server according to some embodiments. 601 All the registered 101 Device Owners individually would be sending their location updates to 102 End Point Server continuously using Global Positioning System (GPS). 602 This information in turn gets stored to the 103 Data Base. 603 The End Point server 102 acknowledges 101 Device Owner's location updates continuously. The Device owners are either job seeker's or job provider's.

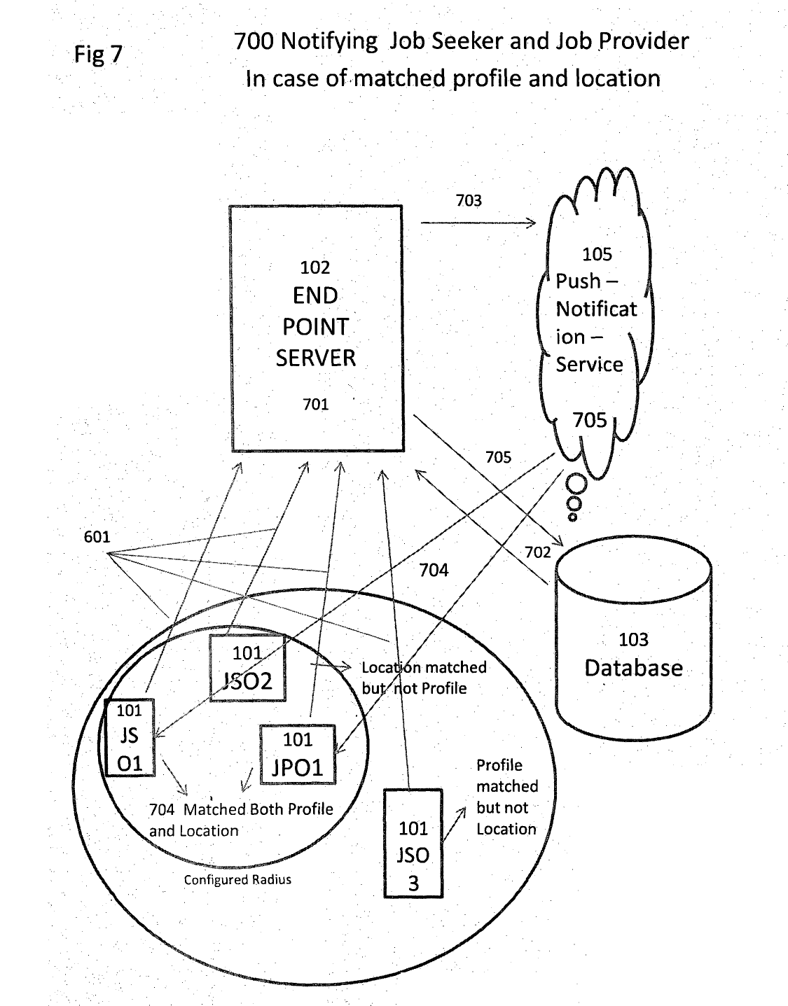

FIG. 7 illustrates the important process steps of notifying the 101 Device Owners' location from the 102 Location Update Server for matching profiles according to some embodiments. 701 The Device Owners' devices 101 keep exchanging their location updates continuously with the 102 EPS. Step 702, the Software Algorithm keeps matching the location and search parameters. 703 Once a match is found with respect to profile and location within the designated radius which is already fixed only for the device which is used by the provider, say a job provider or a seller, an agent who is looking for a daily wager for work etc and not for the seeker of job, buyer, daily wage earner etc, 102 EPS retrieves the corresponding 256 bit registration ID from 103 Data Base. 704 The EPS server 102 sends a message of the matched profiles of the respective users to the 105 Push Notification service (PNS) along with the 101 Device's 256 bit registration ID. Step 705 the Push Notification Service 105 identify the 101 Device Owners whose both profiles and locations are matched within, the configured radius and intimates the respective 101 Device Owners about their respective locations as alerts and messages. Shown by way of an example is an option when there are three job seekers JS 1, 2 and 3 and only job provider JP1. JS 1 is the only match with JP1 with regard to both the predetermined radius and the search criteria. JS 2 matches with JP 1 only with regard to the predetermined distance but not the search criteria, while JS 3 is out of match with regard to both distance as well as search criteria. Therefore only JS 1 and JP 1 are matched for the purpose of this invention.

### DETAILED DESCRIPTION OF THE INVENTION

The present invention relates to a method in which a prospective employee and prospective employer get connected to one another on their mobile devices once their requirements match and the devices are within a predetermined radius of each other, by means of an alert. When both the criteria as well as the fact that the devices are in the predetermined distance, a is notification sent on their respective mobile phones through ping/vibrations. To achieve this, the prospective employee and prospective employer should down load the application of the inventor on their mobile phones and feed the required details. The devices of the Job seekers and Job Providers sense the other related device location through location listeners of the Mobile Operating System and are now ready to connect once they come close within a configured radius and with this the service of the application ends and the prospective employee and prospective employer can thereafter establish their contact as per the details available in the notification screen. The employer can view profiles of prospective candidates and similarly the employee also can view prospective employers in the mobile App.

The present invention seeks to provide an application and service which makes the recruitment process effective and efficient, directly resulting in an efficient and an economic way of hiring people. This is a mobile App in which the employees and employers are asked to submit their profiles and this application helps the prospective employee and employer to get connected when they are mutually compatible with the pre-filled information of skills and mutual expectations and when both come in close proximity to one another within the configured radius by notifications on their respective mobiles by a ring/vibration.

In this Mobile application, a profile matching service helps to identify and bring together two or more people i.e. employees and employers. This mobile application is a great HR tool for the employees and the employers alike. This is the uniqueness of the invention.

The broad sequence of steps for using this facility common to both prospective employer and employee are
1. Mobile Number Unique verification.
2. Registration Process for Push Notification Service.
3. Code verification.
4. Profile and requirement filling.
5. Location Updates
6. Notifying Job seeker and Job Provider by buzzer rings/vibrations

The Mobile App is downloaded to the respective mobiles by the user who wants to utilize the service. The device owner is asked to read the Privacy Policy and Terms and Conditions and then if they have agreed then they select their version to continue, which is an acceptance. Further the device owner has to select the User category. In case of HR recruitment there are two categories such as Job Seeker or Job provider. He or she selects the version of the mobile application whether a Job Seeker or a Job Provider. Then the Job Seeker enters his mobile number and commits by pressing the continue button. The Job Seeker's mobile number is sent to the end point server (EPS). The End Point Server generates a verification code and it gets stored/inserted into the Data Base (DB) on the server. Having verified, a verification token is generated and sent to EPS by the DB. The EPS also sends the verification token to the app. Further, the End Point Server (EPS) generates a SMS template and code and it is sent to SMS API. The EPS generated template with code sends SMS to Application on that particular mobile Number of the job seeker. The SMS Code and the verification token are acknowledged. Similarly, in case of the job provider the same steps are followed up to the EPS generated template with code which sends SMS to Application on that particular mobile Number. Thus the present invention has a verification code that is communicated to the users which acts as a verification check and is a security feature.

The Job Seeker's downloaded Application sends Push Notification sender ID and Application ID to Push Notification Server (PNS) on cloud in the Background. Upon Successful registration Push Notification Server (PNS) issues 256 Bit Registration ID to the Job seeker's Device. This device after receiving the 256 Bit Registration ID sends the Registration ID to the End Point Server (EPS). Further, the 256 Bit Push Notification Registration ID gets stored on the data base against the Job Seeker's mobile number. Similarly, in case of the job provider the same steps are followed and after 256 Bit Push Notification Registration ID gets allotted by the Push Notification Server on cloud, it is first sent to the EPS and then stored against the job provider's mobile number on the data base. The 256 Registration ID and the Verification Code happen simultaneously in the EPS

The next step is when the device owner is asked to upload their verification code and then the App verifies the code which the job seeker or job provider enters. On the job seeker's mobile a verification code is entered when prompted and it is sent by the SMS API. This goes to the End Point Server (EPS). The Data Base compares verification code with verification token, thus restricting the user from using multiple devices. Further, the Data Base creates a result of the comparison of the verification code with verification token on the DB. This information is sent to the End Point Server which gets referred back to the Mobile App. If the job seekers verification token and verification code match on the App, then it continues with the next step, and if there is a mismatch then the Job Seeker's device App prompts the user to verify again. Similarly, in case of the job provider the same steps are followed. Job Seeker's Token Response is the primary key of that Job Seeker and similarly the Job Provider's Token Response is the primary key of that Job Provider. The End Point Server sends a Job provider a Token Response (Primary Key to that Job provider). Now the job provider's device is all set to receive the alerts.

In one example with a job seeker, the Job Seeker's application opens with an introductory screen. The Job seeker's application now provides four screens Viz., Profile, HR Alert, Notification and Share to enter information and choices of the Job Seeker. The Job Seeker's application asks the Job Seeker to fill up his profile Viz. Add Photo, First Name, Last Name, Qualification, status as Fresher/Employee/Freelancer, Designation, Area, City, Present Company, Experience, Mobile, Skill sets, Email Address and attach resume if available. There is a set of preloaded data from which the job seeker can choose to fill in his skill sets. The Job Seeker then goes to the Notification screen to ON/Off button. If this button is in OFF position, then there will be an alert asking the Job Seeker to enable GPS. The Job Seeker's Notification Screen also has three modes of Alerts (i) Ring, (ii) Vibrate, (iii) vibrate and ring. The job seeker has to make a choice here to one of them which can be changed later, if required. The profile of the job seeker can be amended at any point of time by the job seeker and then job seeker then has to upload the same and the matching will take place only with the new data that has been entered and not the old one. The Job Seeker's HR Alert Screen is ready to get Alerts about the available jobs. Further, the Job seeker's share screen provides sharing of the App by Bluetooth, copy to clipboard, drive, email, gmail, google+, hangouts, memo, messages, whatsapp and wifi direct to his contacts. The Job Seekers Profile is sent to End Point Server. The End Point Server sends a Job seeker Token Response (Primary Key to that Job Seeker). Now the job seeker's device is all set to receive the alerts. The job seeker has no range within which the App will connect him to prospective employers. As long as the criteria match, the job seeker will continue to receive alerts wherever he or she travels.

In case of the Job provider the initial activity remains similar. First, the Job provider's application opens with an introductory screen. The Job provider's application now provides five screens namely Profile, Requirement, Candidate Alert, Notification and Share. The Job Provider's application in the profile screen asks the Job Provider to fill up entity profile such as Adding Logo, Entity Name, Area, City, Registered/Alternative Phone Number, email, Website and freeze the company details and click on the save button. If the Job. Provider wishes to update any of changes in the Entity details, he can do so and click on the Update Button. The next step is to proceed to the requirement screen, wherein three options are provided for the job provider to select with regard to the constitution of the entity whether the entity is hiring for itself in which event the job provider clicks on Direct. In the event the hiring is on behalf of another, then the job provider has to state whether it's a consultancy or a freelancer. The next step is to fill in the details of the employer such as Employer Name, Designation, Required Skill sets (which is to be selected from an existing set of skills from a preloaded database), Job Location, Experience, Salary and the job provider then clicks on the save button to freeze the requirement. The job provider cannot edit the requirements with regard to skill sets once it is frozen. The present invention seeks to levy a payment mode for use of the App. Both or either the job seeker or the job provider may have to pay for use of the App, in which case, there is a payment gateway through which the payment is made.

The job provider can register for multiple entities or multiple vacancies for the same entity. All the requirement options are serviced simultaneously. Later, as in the case of the Job seeker the job seeker, the Job provider goes to the Notification screen to choose ON/OFF button. If it is in OFF position there will be an alert asking the Job provider to enable GPS. The Job provider's Notification Screen also has three modes of Alerts (i) Ring, (ii) Vibrate, (iii) vibrate and ring. The Job provider has to make a choice here to one of them which can be changed later, if required. Lastly, the Job provider's Candidate Alert Screen is provided to alert the available candidates when they come in the programmed proximity. The Device Owner's share screen provides sharing by Bluetooth, copy to clipboard, drive, email, gmail, google+, hangouts, memo, messages, whatsapp, wifi direct, share it, skype, viber and/or any other such facility likely to be used in future for sharing and storing. Job provider Profile is sent to End Point Server. The End Point Server sends the Job provider a Token Response (Primary Key). Now the Job provider's device is all set to receive the alerts. The job provider can also share the App in the same manner as the job seeker. Multiple job seeker's and job provider's devices are ready to receive alerts once registered, following the procedures laid herein above. An alert is issued to the device by means of an icon displayed on the menu bar of the device. A list of job providers and job seekers are displayed on the respective Alert screens of the job seekers and job providers respectively. The information for communicating between the job provider and seeker is that in profile screen when clicked upon. The job seeker/provider can then can contact the job provider/seeker by any of the means listed therein and schedule an interview, resulting in real time communication.

The job provider too has preloaded data from which he chooses the information such as skill sets and chooses the predetermined radius in which the Job Seekers will come into contact with the job provider will start working. The Job provider can fill up multiple requirements and get multiple matches for each requirement but cannot edit the requirements in the requirement screen once uploaded unlike the job seeker who can always edit.

Further the design of obtaining and updating the location information of job seeker and job provider from their respective Devices to the server is yet another feature of this invention. All the registered job seekers individually would be sending their location updates to end point server continuously which in turn gets stored to the Data Base. The End Point server acknowledges Job Seeker location updates continuously. The various Job Provider profiles send location updates to end point server continuously which in turn gets stored to Data Base. The End Point server acknowledges Job Provider location updates continuously.

The most important feature of this invention is the feature of notifying the job seeker and job provider location from the Location Update server while simultaneously matching criteria listed by both parties i.e. matching profile with requirement. As the job seeker and job provider devices keep exchanging their location updates continuously with the EPS, the Software Algorithm keeps matching the location and search parameters. Once a match is found with respect to profile and location within the designated radius, EPS retrieves the corresponding 256 bit registration ID from Data Base. The EPS server sends a message of the matched profiles of the respective users to the Push Notification service (PNS) along with the Device's 256 bit registration ID. The Push Notification Service identify the Job Seekers and Job Providers whose profiles and locations are matched within the configured radius and intimates the respective job seekers and Job providers about their respective locations as alerts and messages.

Yet another feature of the invention is that the job seeker has no preset limit with regard to the functioning of the App whereas the job provider has a preset limit within which only the matches will take place. Thus the job seeker can come across a match pretty much anywhere as long as the information matches, as there is no location limitation at all. This facilitates a match in another city, where the job seeker is travelling in and facilitates job matches across many cities as far as the job seeker is concerned. Even if the job seeker is only curious about his worth, a download of the App will help him recognize his worth pretty much anywhere in the world. The Job Provider can also move from one city to another and he will get notification if any match happens within the predetermined radius from the place where the Job Providers device is located.

Payment is an option for both the job seeker and the job provider. The profiles and requirements updated in such an event would be restricted to a predetermined time frame and payment modules. The number of job vacancies searched for would also be restricted depending upon the payment modules.

Disclosed is method for an App to connect a job provider and a job seeker through GPS (Global Positioning System). The description which is presented is to enable a person of ordinary skill in the art to make the use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions therefore, of the illustrated method. Additionally, the format and symbols employed are provided to explain the logical steps of the methods and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instances, an arrow may indicate a waiting or monitoring period of unspecified duration between enumerated steps of the depicted method. Additionally, the order in which a particular method occurs may or may not strictly adhere to the order of the corresponding steps shown.

In addition, it can be appreciated that the various operations, processes, and methods disclosed herein can be embodied in a machine-readable medium and/or a machine accessible medium compatible with a data processing system (e.g. a computer system), and can be performed in any other (e.g. including using means for achieving the various operations). Accordingly, the specification and drawings are to be regarded in an illustrative rather than a restrictive sense. In some embodiments, the machine-readable medium can be a non-transitory form of machine-readable medium.

I claim:

1. A method of providing a match between a job provider and a job seeker using devices over a telecommunication network in real time mode; using an App matching both predetermined location range of the job provider with the location of the job seeker and matching the profiles of a job seeker with the requirements of a job provider; communicating such matches to both devices by means of an alert; making use of hardware systems such as End Point servers; Data Bases; Internet services, cloud services such as Push Notification Service, public telecommunication services; mobile operating services; Global Positioning System (GPS); the said method comprising the steps of:
Downloading the App; Installing the same on the respective devices; each of the devices being authenticated and verified using an End Point Server template; Registration of the devices wherein the user commits by agreeing to the terms of use and privacy policy and other conditions; a verification code generated for each device; the said code communicated to each device by means of an SMS API; the verification code being stored on the Database of the End Point Server; each device also being allotted a unique verification token being generated by the Database; communicated to each device through End Point Server; Setting up the code verification of the stored data with the entered details from the device; and confirming the same; if different calling for verification again from the device;
Setting up the data capture of the profile of the job seeker and job provider; storing the same on the End Point Server; obtaining the Job seeker's and Job Provider's Token response from the End Point Server; the said Token responses being the respective primary key of the job, seeker and job provider;
Registering the devices for Push Notification Service with push notification servers; the said PNS issuing a unique 256 bits registration id for each of the devices; each device communicating this, unique 256 bits registration to the End Point Server; the unique 256 bits registration stored against the device information on the End Point Server;
Setting up updating and storing of the location change from the devices continuously; the said information being sent to the End Point Server using GPS as the same is updated; the said information then sent to the Data base; such information stored after continuously acknowledging the location updates with the devices;
Matching said location updates with the profile of the job seeker and the requirements of the job provider and their respective 256 bits registration ID being retrieved from the data base; sending this information to the Push Notification Service along with the matched criteria; the Push Notification Service sending the alerts to the devices for the matched criteria and location information where both the job seeker and job provider's mobile device are within the pre-set radius;
Issuing an alert to the registered devices by means of an icon displayed on the menu bar of the device; listing out the information of the potential job providers/seekers as provided in the profile screen;
Enabling the job provider and job seeker to communicate in real time mode to schedule a meeting in real time; thereby doing away with the time lag associated with conventional methods employed by HR personnel; saving time, money and increasing the efficiency with which the job vacancies are filled; resulting in quicker turnaround time for the job providers resulting in higher efficiency in filling up vacancies which result in direct economic growth and efficiency.

2. A method as claimed in claim 1, wherein registering the device on the Push Notification Server comprises of the Job Seeker's or Job provider's downloaded App sending Push Notification sender ID and Application ID to Push Notification Server on cloud; PNS issues 256 bits registration ID to the device after successful registration; the 256 bits registration ID being sent by the device to the End Point Server and stored on Data Base.

3. A method as claimed in claim 1, wherein the authentication of the device comprises of the user's Mobile entering a verification code sent by SMS API; sending the same to the EPS; wherein the DB compares the verification code with the verification token; permitting the user to proceed to the next stage only upon successful match.

4. A method as claimed in claim 1, where in the job seeker's profile and requirement comprises of:
a) Job seeker's application opening an Introductory screen with four options Profile, HR Alert, Notification and Share;
b) Job Seeker filling information such as adding a Photo, First Name, Last Name, Qualification, Fresher/Employee/Freelancer, Designation, Area, City, Present Company, Experience, Mobile, Skill sets (from a preloaded database), Email Address, attach resume if any on the Profile Screen;
c) Job seeker proceeding to Notification screen to switch on GPS using the ON/Off button; receiving an alert to switch on the same if it is in OFF position;
d) Job seeker clicking on the option to receive alerts on the Notification Screen;
e) Job Seeker's completed profile being sent to End Point Server;
f) The end Point Server sending a Token Response (Primary Key to that Job Seeker) to enable the job seeker's device to receive the job alerts;
g) The Job Seeker's HR Alert Screen ready to receive the list the available jobs;
h) The Job seeker's share screen providing for sharing the App by Bluetooth, copy to clipboard, drive, email, gmail, google+, hangouts, memo, messages, whatsapp, wifi direct to any of the contacts in the job seeker's contact list;
i) The profile of the job seeker capable of being amended at point of time; the matching happening only with the most recent upload;
j) Receiving an alert once the criteria and location match with devices.

5. A method as claimed in claim 1, where in the Profile and requirement filling of the job provider comprises of:
a) Job Provider's application opening to an Introductory screen with five options: Profile, Requirement, Candidate Alert, Notification and Share;
b) Job Provider entering details in the profile screen such as the details of the Entity Name, Logo, Area, City, Registered/Alternative Phone Number, email, Website;
c) Job provider entering the details in the Requirement screen such as Entity Type whether direct hire or consultancy or freelancer; then the Employer details such as Employer's name, Designation, Required Skill Set (from preloaded Database), Job Location, Experience; Salary; freezing the same on completing the details required by clicking on the save button;
d) Job provider clicking on update button in the event of any changes to the aforementioned information save the Requirement Screen;
e) Job Provider proceeding to the Notification screen to switch on GPS using the ON/Off button; receiving an alert to switch on the same if it is in OFF position.
f) Job provider clicking on the option to receive alerts on the Notification Screen;
g) Job provider's completed profile being sent to End Point Server;
h) The End Point Server sending a Token Response (Primary Key to that Job Seeker) to enable the job provider's device to receive the job alerts;
i) The Job provider's HR Alert Screen ready to receive the list the available candidates;
j) Job provider's share screen providing for sharing the App by Bluetooth, copy to clipboard, drive, email, gmail, google+, hangouts, memo, messages, whatsapp, wifi direct to any of the contacts in the job provider's contact list;
k) The profile of the job provider capable of being amended at point of time; save the details of the requirement screen; the matching happening only with the most recent upload;
l) Receiving an alert once the criteria and location match with devices.

6. A method as claimed in claim 1, for Location updates of the job seeker or job provider comprising of:
a) Job seekers whose profiles are registered sending location updates to end point server which is further sent to the Data Base
b) The End Point server acknowledging Job Seeker's location updates continuously
c) Job Providers whose profiles are registered sending location updates to end point server which is further sent to the Data Base
d) The End Point server acknowledging Job Provider's location updates continuously
e) Matching location updates once the job provider and the job seeker come within a predetermined radius of each other.

7. A method as claimed in claim 1, wherein an alert is issued to both the job seeker and job provider comprising the steps of:
a) The Job Seeker's and Job Provider's mobile devices sending location updates to EPS constantly;
b) The EPS Algorithm matching location and search criteria put up by both job provider as well as job seeker;
c) The EPS retrieving the 256 bits registration ID from Data Base of both job provider as well as job seeker;
d) The EPS sending messages of the matched profiles of the respective users to the Push Notification service along with the Device's 256 bit registration ID;
e) The Push Notification Service identifying the Job Seekers and Job Providers when both profiles and locations are matched and when they are within the predetermined radius of the job provider by means of an alert to intimate the respective job seekers and Job providers about the match.

8. The method as claimed in any of the preceding claims wherein the job seeker's locating and matching functions have no predetermined radius within which to work.

9. The method as claimed in any of the preceding claims wherein the job provider can list multiple requirements on a single device.

10. The method as claimed in any of the preceding claims wherein the job provider chooses the predetermined radius.
